(19) United States
(12) Patent Application Publication
(10) Pub. No.: US 2015/0088690 A1
(43) Pub. Date: Mar. 26, 2015

(54) DISTRIBUTING AND USING BOOKMARK MENUS TO PRESENT INFORMATION

(71) Applicant: MobilePoint Corporation, Irvine, CA (US)

(72) Inventor: Timothy Edward Titus, Newport Beach, CA (US)

(73) Assignee: MobilePoint Corporation, Irvine, CA (US)

(21) Appl. No.: 14/034,461

(22) Filed: Sep. 23, 2013

(51) Int. Cl. G06Q 30/06

(52) U.S. Cl. CPC G06Q 30/0623
USPC 705/26.61

(57) ABSTRACT

A method includes displaying a bookmark menu that includes a plurality of selectable elements during presentation of information associated with at least one of a product and a service at an electronic device. Each of the plurality of selectable elements may be associated with a conversation topic included in a set of conversation topics related to at least one of the product and the service. The method includes initiating presentation of first conversation content at the electronic device in response to receiving an input indicating a selection of a first selectable element of the plurality of selectable elements. The first conversation content may be associated with a first conversation topic related to at least one of the product and the service

### CROSS-REFERENCE TO RELATED APPLICATIONS

The present application is related to co-pending and concurrently filed U.S. patent application Ser. No. ______, Attorney Docket No. MBPT.P0001US, entitled “CONVERSATION AND OPPORTUNITY MESSAGE SHARING.”

### TECHNICAL FIELD

The present disclosure is generally related to sharing and using bookmark data to present information.

### BACKGROUND

Portable electronic devices are increasingly being used to conduct business. For example, portable electronic devices include email messaging and text messaging capabilities that have gained wide-spread used in business environments. However, such capabilities are limited in functionality. For example, a sales person may meet with, and present information to a customer related to a particular product. If the sale representative needs to contact another person (e.g., a representative of a manufacturer that makes the particular product) to schedule a follow-up meeting between the customer and the other person, the sales representative must manually type information (e.g., in an email or in text message) that indicates the information the sales representative has presented to the customer. This requires the sales representative to remember the information that was presented to the customer, which can be difficult. This may result in inaccurate information or incomplete information being reported to the other sales representative, and may also result in the other sales representative not having the right information to properly evaluate what should be presented to the customer during the follow-up visit. This may lead to a poor customer experience as the customer may be presented information that he has already seen during his visit with the first sales representative.

Additionally, selecting information form a large set of possible information may be difficult when using a portable electronic device. For example, when presenting information about a product to a customer, the customer may have a question regarding a particular aspect of the product and the sales representative may have difficulty locating information that is relevant to the question asked by the customer. Thus, although portable electronic devices include capabilities that have become widely used in business environments, use of such capabilities in particular environments may present users with challenges.

### SUMMARY

Embodiments of methods, systems, apparatuses, and computer-readable storage media for generating and sharing conversation information and opportunity information are disclosed herein. Additionally, embodiments of methods, systems, apparatuses, and computer-readable storage media for generating, distributing, and using bookmarks to present information using an electronic device are disclosed herein. The disclosed embodiments may enable increased and faster communication between persons involved in a coordinated task, such as team sales. For example, in a team sales environment a sales representative for a distribution company may initially meet with a potential customer to discuss a product or service that the sales representative believes the potential customer may be interested in. During the meeting the sales representative may use an electronic device (e.g., a tablet computing device, a laptop computing device, etc.) to present information descriptive of the product or service to the customer. The information may describe various features of the product or the service, improvements that the product or the service may provide to the potential customer's work flow and/or productivity, how the product or service may benefit the customers of the potential customer, and other aspects of the product or the service.

In many instances, the sales representative may have a limited amount of time to present the information to the potential customer. For example, in a hospital setting, the sales representative may present information descriptive of a medical product or medical service to a physician in between patients. In some instances the information may be presented to the physician while walking down a hallway. In such circumstances, the sales representative may have difficulty tracking the information that was presented to the physician. One or more of the embodiments described herein may automatically create a conversation log that identifies the information presented to the physician. The conversation log may also identify the order in which the information was presented to the physician.

During the presentation, the physician may ask questions about a particular aspect of the product or the service, such as how the product or the service will improve patient care, how the product or the service will improve patient comfort, or how the product or the service will improve increase the physicians workflow. One or more of the embodiments described herein may enable the sales representative to use bookmarks to quickly identify and present information responsive to the physician's questions. This may increase the likelihood that the physician will purchase the product or the service. Additionally, use of bookmarks according to one or more of the embodiments described herein may enable presentation of information related to the product or service at the customer's direction (i.e., on demand). For example, when the physician asks the sales representative how the product or the service will improve patient care, the sales representative, may use bookmarks to quickly identify and present information (e.g., scientific studies, test results, etc.) to the physician that describes various ways that the product or the service will improve the care of the physician's patients. The ability to quickly find the relevant information may enable the sales representative to present more information to the physician in a limited amount of time and may also increase the amount of time that the physician is willing to spend learning about the product or the service that the sales representative is promoting.

After the sales representative has finished discussing the product or the service with the customer (e.g., the physician), the sales representative may desire to contact second sales representative, such as a sales representative employed by a manufacturer of the product or a provider of the service, to request that the second sales representative follow-up with the customer (e.g., the physician). One or more of the embodiments described herein may enable the sales representative to initiate, using a first electronic device, transmission of an opportunity message (e.g., an email message) that includes at least a portion of the conversation log (e.g., a list of the information presented to the customer) to an electronic device associated with the second sales representative. In an embodiment, the opportunity message may include additional information, such as notes, inputted by the sales representative. The notes may provide information to the second sales representative that may help the second sales representative prepare for the follow-up with the customer.

Additionally, when the sales representative transmits the opportunity message to the second electronic device, the first electronic device may also transmit an opportunity record that includes the information from the conversation log and the additional information (e.g., the notes) to a server. The second sales representative may use an application installed on the second electronic device to access the opportunity record stored at the server. In an embodiment, the opportunity record may be included in the opportunity message as an attachment and the second sales representative may import the opportunity record into the application using the attached opportunity record. Thus, one or more of the embodiments described herein may enable faster and more accurate information sharing between persons involved in a shared task, such as team sales.

In an embodiment, a method includes automatically generating a log that identifies information presented at a first electronic device. The method may include, in response to receiving a request to transmit at least a portion of information included in the log to a second electronic device, initiating transmission of at least the portion of the information included in the log from the first electronic device to the second electronic device via a network, and initiating transmission of the log from the first electronic device to a server via the network. The server may be configured to store the log in a database, and the log may be accessible to the second electronic device via the server.

In an embodiment, an apparatus includes a processor and a memory coupled to the processor. The memory may store instructions that, when executed by the processor, cause the processor to perform operations that include initiating presentation of information at a presentation device communicatively coupled to the processor. The operations may include automatically generating a log that identifies the presented information. The operations may include initiating transmission of at least the portion of the information included in the log to the electronic device via a network in response to receiving a request to transmit at least a portion of information included in the log to an electronic device, and initiating transmission of the log to a server via the network in response to receiving a request to transmit at least a portion of information included in the log to an electronic device. The server may be configured to store the log in a database, and the log may be accessible to the electronic device via the server.

In an embodiment, a computer-readable storage device includes instructions that, when executed by the processor, cause the processor to perform operations that include initiating presentation of information at a presentation device communicatively coupled to a first electronic device, and automatically generating a log that identifies presented information. The operations may include, in response to receiving a request to transmit at least a portion of information included in the log to a second electronic device, initiating transmission of at least the portion of the information included in the log to the second electronic device via a network, and initiating transmission of the log to a server via the network. The server may be configured to store the log in a database, and the log may be accessible to the second electronic device via the server.

The foregoing has outlined rather broadly the features and technical advantages of the present invention in order that the detailed description of the invention that follows may be better understood. Additional features and advantages of the invention will be described hereinafter which form the subject of the claims of the invention. It is noted that many of the embodiments described herein are illustrated using a sales or team sales example. Such illustrations and examples are to be considered illustrative and not limiting on the present disclosure. For example, one or more of the embodiments described herein may be used outside of a sales or team sales implementation. It should be appreciated by those skilled in the art that the conception and specific embodiment disclosed may be readily utilized as a basis for modifying or designing other structures for carrying out the same purposes of the present invention. It should also be realized by those skilled in the art that such equivalent constructions do not depart from the spirit and scope of the invention as set forth in the appended claims. The novel features which are believed to be characteristic of the invention, both as to its organization and method of operation, together with further objects and advantages will be better understood from the following description when considered in connection with the accompanying figures. It is to be expressly understood, however, that each of the figures is provided for the purpose of illustration and description only and is not intended as a definition of the limits of the present invention.

### BRIEF DESCRIPTION OF THE DRAWINGS

For a more complete understanding of the present disclosure, reference is now made to the following descriptions taken in conjunction with the accompanying drawing, in which:

FIG. 1 is an illustrative embodiment of a system for communicating information between remote electronic devices during performance of a shared task;

FIG. 2 is an illustrative embodiment of synchronizing updated opportunity data in the system 100 of FIG. 1;

FIG. 3 is an illustrative embodiment of presenting information at the first electronic device 110 of FIG. 1;

FIG. 4 is an illustrative embodiment of presenting conversation content at the first electronic 110 of FIG. 1 using the bookmark menu 374 of FIG. 3;

FIG. 5 is an illustrative embodiment of an opportunity record generated based on a conversation log;

FIG. 6 is an illustrative embodiment of an opportunity message;

FIG. 7 is an illustrative embodiment of an updated opportunity message;

FIG. 8 is a flowchart of an illustrative embodiment of a method of sharing information between multiple electronic devices involved in a coordinated task; and

FIG. 9 is a flowchart of an illustrative embodiment of a method of presenting conversation content using a bookmark menu that includes a plurality of selectable elements.

### DETAILED DESCRIPTION

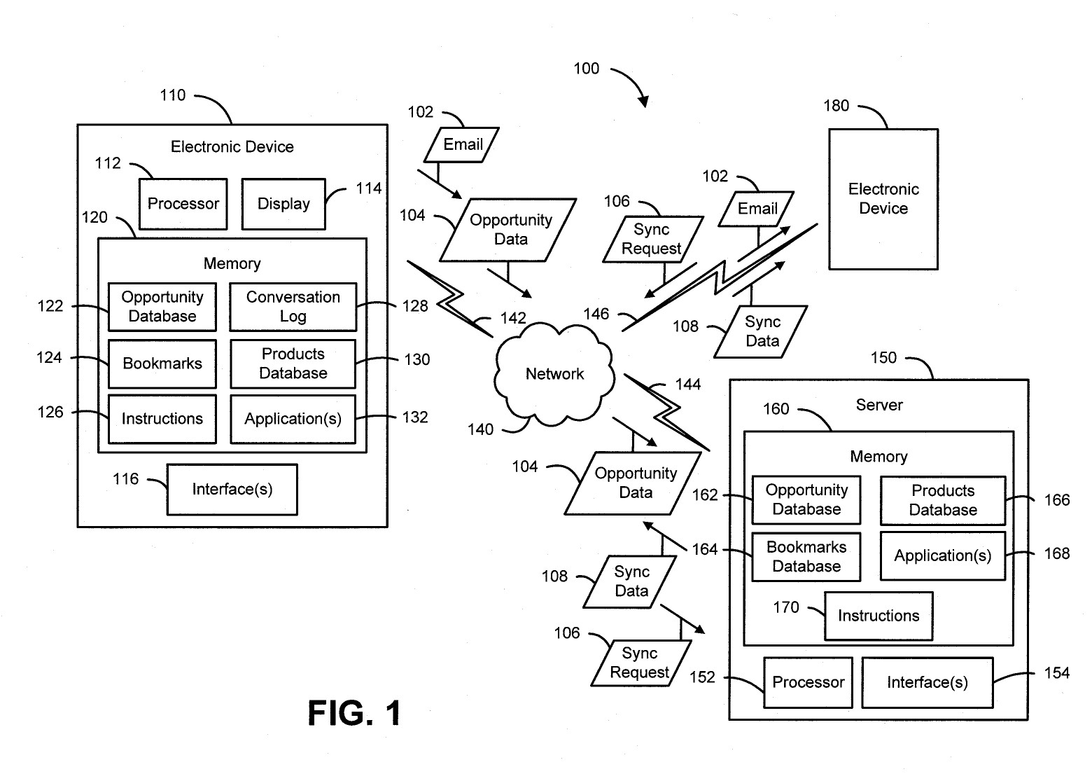

Referring to FIG. 1, an illustrative embodiment of a system for communicating information between remote electronic devices during performance of a shared task is shown and designated 100. As shown in FIG. 1, the system 100 includes a first electronic device 110, a network 140, a server 150, and a second electronic device 180. The first electronic device 110 and the second electronic device 180 may be a tablet computing device, a laptop computing device, a personal computing device, a smartphone, a personal digital assistant (PDA), cellular phone, a wireless communication device, or other electronic device operable to perform the various functions described herein with reference to FIG. 1-9.

The first electronic device may be coupled to the network 140 via a first communication link 142, the server 150 may be coupled to the network via a second communication link 144, and the second electronic device 180 may be coupled to the network 140 via a third communication link 146. The network 140 may be a wireless network (e.g., cellular data network, an IEEE 802.11 compatible wireless network, etc.), a wired network, or a combination of wireless and wired networks. For example, the network 140 may include a local area network (LAN), a wide area network (WAN), wireless local area network (WLAN), a public network, such as the internet, a private network, or may be a combination of these types of networks. The communication links 142, 144, 146 may be wireless communication links, wired communication links, or a combination thereof.

As shown in FIG. 1, the first electronic device 110 may include a processor 112, a display device 114, a memory 120, and an interface(s) 116. In an embodiment, the display device 114 may be incorporated within the first electronic device 110, such as an electronic device having a built-in display device In an embodiment, the display device 114 may be a touchscreen display device. Alternatively, the display device 114 may be external to the first electronic device 110 and may be coupled to first electronic device 110 via one or more of the interface(s) 116.

The interface(s) 116 may include an output interface, such as audio interface including one or more speakers, encoders, decoders, etc., for encoding, decoding, and playing audio at the first electronic device 110. The interface(s) 116 may include a network interface for communicating with one or more networks or devices. In an embodiment, the network interface may include a wireless network interface (e.g., a wireless receiver, a wireless transmitter, or a wireless transceiver) for receiving wireless communications. Alternatively or additionally, the network interface may include a wired network interface (e.g., an RJ11 connector, an RJ45 connector, etc.) for coupling the first electronic device 110 to a network via a cable. The interface(s) 116 may include one or more peripheral interfaces (e.g., a universal serial bus (USB) interface, a firewire interface, etc.) for coupling one or more peripheral devices (e.g., a keyboard, a display device, etc.) to the first electronic device 110. The interface(s) 116 may include an input/output interface that enables a user of the first electronic device 110 to provide input to the first electronic device 110. For example, the input/output interface may include a touchscreen. Alternatively or additionally, the user may provide input to the first electronic device 110 via a peripheral device, such as a keyboard coupled to the peripheral interface. The interface(s) 116 may include other interfaces that may be enable the first electronic device 110 to perform the various functions and operations described herein and the previously described interfaces are intended to serve as examples of the types of interfaces that may assist a user of an electronic device in performing the functions and operations described herein.

The memory 120 may include one or more memory devices (e.g., hard disk drives, random access memory (RAM) devices, read only memory (ROM) devices, etc.). The memory 120 may store information that may be used by the first electronic device 110 to perform the various functions and operations described herein. For example, the memory 120 may include a products database 130 and an application(s) 132. The application(s) 132 may be executed by the processor 112 to present information retrieved from the products database 130 at the display device 114. The products database 130 may include information (e.g., promotional materials, video demonstrations, instructional videos, and other informative materials) that may be used to sell, describe, explain, and/or promote a product or a service. Additionally, the application(s) 132 may be stored as the instructions 126 and may include instructions that, when executed by the processor, cause the processor to perform the functions and operations described herein with reference to FIGS. 1-9.

In an embodiment, a manufacturer of the product or a provider of the service may generate the information (e.g., the promotional materials, the video demonstrations, the instructional videos, and the other informative materials) and may upload (or otherwise store) the information at the products database 166 stored at the memory 160 of the server 150. A user of the first electronic device 110 (e.g., a sales representative of a distributor) may use the application(s) 132 to download the information from the products database 166 via the network 140 and may store the information at the products database 130. In an embodiment, the application(s) 132 may dynamically sync the information stored at the products database 130 with the information stored at the products database 166 (e.g., upon initializing the application(s) 132). In an additional or alternative embodiment, the server 150 may push new information to the first electronic device 110 when the products database 166 is updated (e.g., when new information is stored at the products database 166).

It is noted that the second electronic device 180 may include one or more of the elements (e.g., one or more of the processor 112, the display 114, the memory 120, the interface(s) 116, and the elements stored at the memory 120) described with reference to the first electronic device 110 and that those elements are not shown for simplicity of description and to simplify FIG. 1. For example, although not shown in FIG. 1, the second electronic device 180 may include a processor, a display device, a memory, and interfaces similar to those described with reference to the first electronic device 110. Additionally, the memory of the second electronic device 180 may store instructions that, when executed by the processor of the second electronic device 180, cause the processor of the second electronic device 180 to perform the various functions and operations described with reference to FIGS. 1-9.

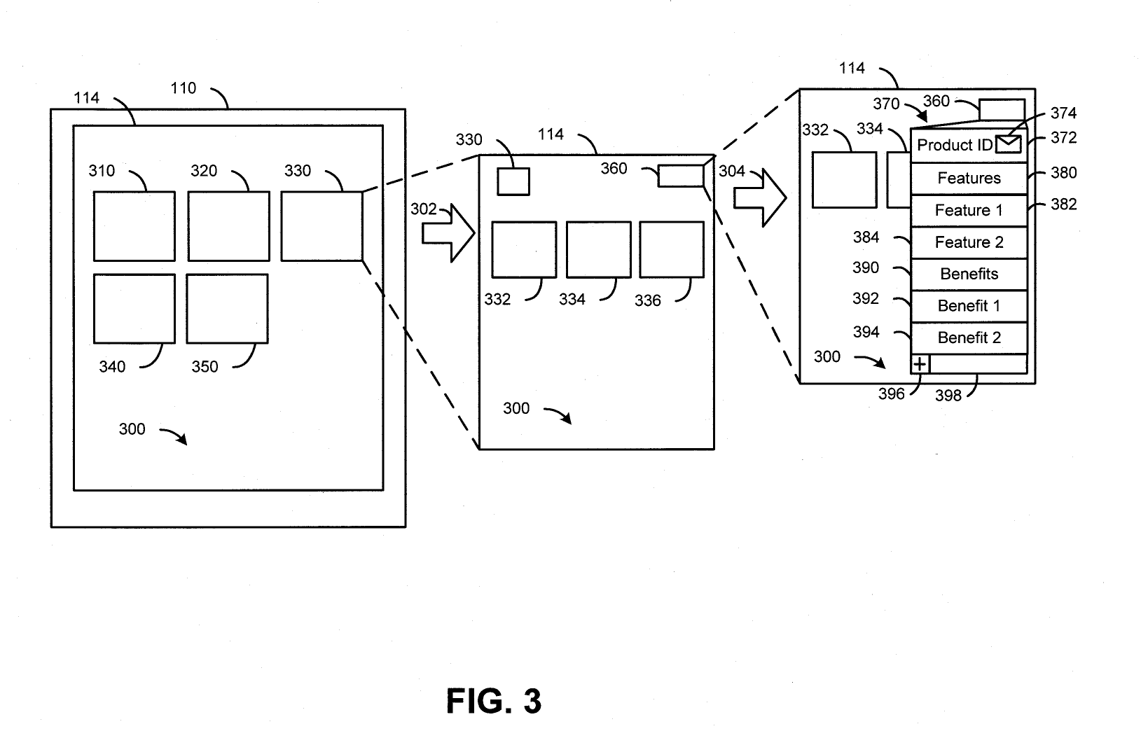

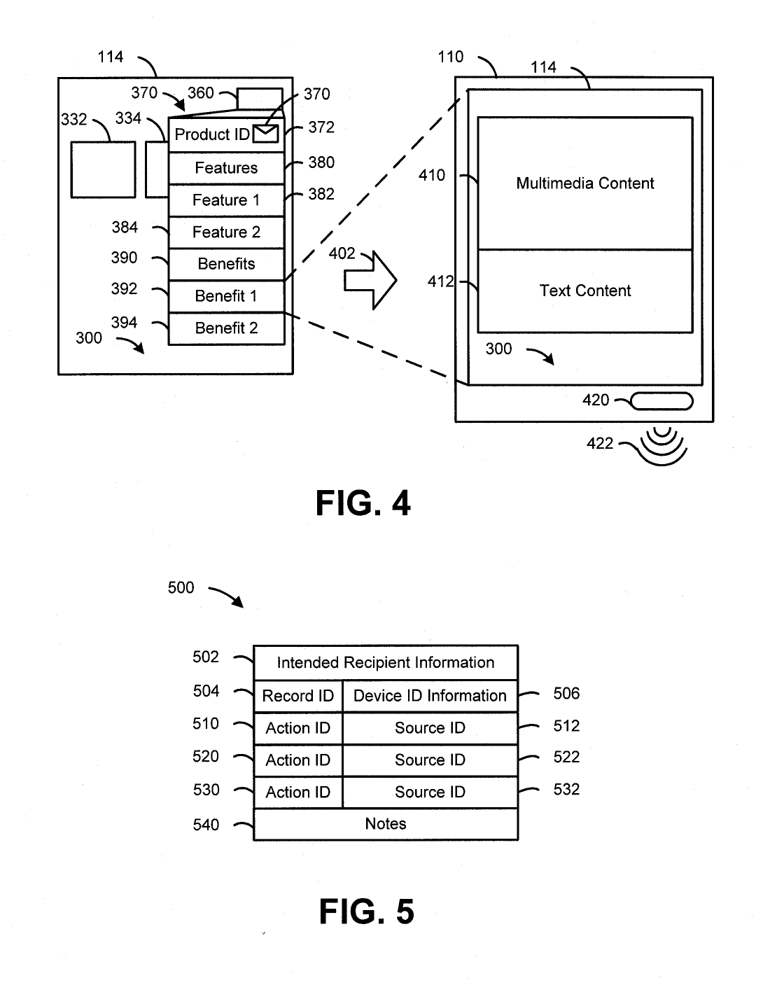

During operation, the user of the first electronic device 110 may initiate a conversation with a customer to discuss a potential sale of a product or a service. During the conversation with the customer, the sales representative may use the application(s) to present information from the products database 130 to the customer. When presenting the information to the customer, the application(s) 132 may present a bookmark menu retrieved from a bookmarks database 124 stored at the memory 120 of the first electronic device 110. The bookmark menu may classify the information associated with the product according to one or more criterion (e.g., a benefit of the product, how to use the product, etc.). An illustrative embodiment of presenting information to the customer using the bookmark menu is described with reference to FIGS. 3 and 4.

The information may be presented to the customer at the display device 114 of the first electronic device 110. Additionally or alternatively, a portion of the information may be presented to the customer using one or more of the interface(s) 116. For example, the audio interface may be used to present audio information to the customer while other information is presented to the customer via the display device 114 (e.g., when the information presented to the customer includes text, video, and/or image content and audio content). The first electronic device 110 may automatically generate a conversation log 128 that identifies the information presented to the customer. The conversation log 128 may also identify an order in which the information was presented. In an embodiment, the order in which the information is presented may be indicated using timestamps. An illustrative embodiment of information that may be included in the conversation log 128 is described with reference to FIG. 5.

After concluding the meeting with the customer, the sales representative may provide an input to the application(s) 132 requesting to transmit an opportunity message 102 that includes at least a portion of information included in the conversation log 128 to the second electronic device 180. In response to receiving the input requesting to transmit the opportunity message 102 to the second electronic device 180, the first electronic device 110 may, present a graphical user interface provided by the application(s) 132. The graphical user interface may enable the sales representative to select one or more intended recipients of the opportunity message 102 from a contacts list (not shown in FIG. 1). In addition to the conversation log 128, the opportunity message 102 may include additional information (e.g., notes inputted by the sales representative that describe the conversation with the customer, actions to be taken or information to be discussed with the customer in a follow-up visit, etc.).

The first electronic device 110 may initiate transmission of the opportunity message 102 from the first electronic device 110 to the second electronic 180 device via the network 140 using the communication links 142, 146. In an embodiment, the opportunity message 102 may be an email message and may be transmitted from the first electronic device 110 to an email server (not shown in FIG. 1) that is coupled to the network 140. In an embodiment, the first electronic device may generate an opportunity record and store the opportunity record at the opportunity database 120. The opportunity record may include a first identifier that uniquely identifies the opportunity record from a plurality of opportunity records stored in the opportunity database 122. Additionally, the opportunity record may include a second identifier (e.g., an international mobile subscriber identity (IMSI) number, a unique device identifier (UDID), a media access control (MAC) address) associated with the first electronic device 110. In an embodiment, the opportunity record may be attached to the opportunity message 102. The second electronic device 180 may receive the email message (e.g., the opportunity message 102) from the email server via the network 140 using the communication link 146.

By sending the opportunity message 102 to the second electronic device 180, a user of the second electronic device 180 may be quickly informed of the conversation between the sales representative and the customer and the information that has been presented to the customer. For example, in a team sales environment, the sales representative may be employed by a distribution company that distributes products on behalf of a manufacturer. The user of the second electronic device may be a second sales representative that works for the manufacturer and that performs follow-up visits with customers that the sales representative has had conversations with. By sending the opportunity message 102 to the second electronic device 180 (e.g., the electronic device of the second sales representative), the second sales representative may be able to schedule quicker follow-up visit with the customer, reducing an amount of time required to potentially close a sales deal. Additionally, because the opportunity message 102 identifies the information that has already been presented to the customer, the second sales representative may prepare for the follow-up visit immediately after receiving the opportunity message 102. Thus, in busy environments, such as hospitals, where customers have limited amounts of time to meet with sales representatives, the ability to quickly prepare for meetings with customers using the opportunity message 102 may be critical to the success of a potential sale.

The opportunity records stored at the opportunity database 122 may identify open sales opportunities. For example, after the sales representative concludes his or her conversation (i.e., presenting the information) with the customer, the sales representative now has the opportunity to complete the sale. Each opportunity record stored in the opportunity database may document conversations between the sales representative and customers regarding the potential sale of a product or a service. By storing the opportunity records at the opportunity database 122, the sales representative may quickly recall the information presented to the customer during a previous conversation with the customer, reducing a likelihood that the sales representative will present redundant information to the customer during a subsequent conversation.

Additionally, and in response to receiving the request to transmit the opportunity message 102 to the second electronic device 180, the first electronic device 110 may initiate transmission of the opportunity record associated with the conversation log 128 (and the additional information) to the server 150 via the network 140. In an embodiment, the opportunity record may be transmitted to the server 150 as opportunity data 104. The opportunity data 104 may include the additional information (e.g., the notes), as described with reference to FIG. 5. The server 150 may be configured to store the opportunity data 104 at an opportunity database 162. In an embodiment, when the opportunity message 102 does not include the opportunity record, the second electronic device 180 may retrieve the opportunity data 104 from the opportunity database 162 via the server 150. For example, the second electronic device 180 may include an application (e.g., a copy of the application(s) 132) that may sync or otherwise download/copy the opportunity data 104 from the opportunity database 162 to the second electronic device 180. The opportunity message 102 may include the first identifier that uniquely identifies the opportunity record and the application executing on the second electronic device 180 may retrieve the opportunity record based on the first identifier. In an embodiment, the email 102 may include an icon or a link that, when selected, causes the application of the second electronic device 180 to sync (e.g., retrieve the opportunity data 104 from the opportunity database 162) with the server 150. In an embodiment, the opportunity message 102 may include the opportunity record and selection of the link may cause the application of the second electronic device 180 to import the opportunity record into the opportunity database stored at the memory of the second electronic device 180.

In an embodiment, the second electronic device 180, in response to the opportunity message 102, may transmit a message (not shown in FIG. 1) including the first identifier and a third identifier (e.g., an IMSI number, a UDID, a MAC address) associated with the second electronic device 180 to the server 150. The server 150, in response to receiving the message from the second electronic device 180, may store the third identifier with the opportunity data 104 at the opportunity database 162. Subsequently, when the opportunity data 104 stored at the opportunity database 162 is updated or modified (e.g., by the first electronic device 110 or the second electronic device 180), the server 150 may transmit a notification (not shown in FIG. 1) to the appropriate electronic devices to inform the respective application(s) 132 that the opportunity data 104 has been modified. In an embodiment, the notification may include the updated or modified opportunity data 104 and the electronic devices may sync the respective opportunity databases using the updated or modified opportunity data 104 included in the notification. In another embodiment, the notification may indicate the opportunity data 104 associated with the first identifier has been modified and the electronic devices 110, 180 may retrieve the updated or modified opportunity data 104 from the server 150 (e.g., using the application(s) 132). In yet another embodiment, the notification may include only the information that has been modified within the opportunity data 104 and the electronic devices 110, 180 may import the information that has been modified into the respective opportunity databases using the information included in the notification.

After transmitting the opportunity message 102 and the opportunity data 104, the first electronic device 110 may reset the conversation log 128. Resetting the conversation log 128 after transmitting the opportunity message 102 and the opportunity data 104 may limit the information included in the conversation log 128 to a single conversation (e.g., a single meeting between the sales representative and the customer). Further, automatically logging the information presented to the customer in the conversation log 128 relieves the sales representative of the burdensome task of tracking the information that was presented during the conversation.

Because the conversation log 128 includes information indicating the order in which the information was presented, the sales representative is not required to track the order in which the information was presented. Further, the order in which the information was presented may also be used for analysis and evaluation of the effectiveness of the information or to determine whether portions of the information presented are of more interest to customers. For example, analysis of the opportunity records may indicate that information describing how to use the product is frequently presented to the customer immediately after presenting information describing the benefits of the product. This may indicate that customers are interested in the benefits of the product and wanted to learn more about how the product provides those benefits (e.g., by viewing the information describing how to use the product). As another example, analysis of the opportunity records may indicate that information describing how to use the product is frequently presented to the customer multiple times. This may indicate that customers have a hard time understanding information describing how to use the product and that this information may need to be revised to make the description more clear.

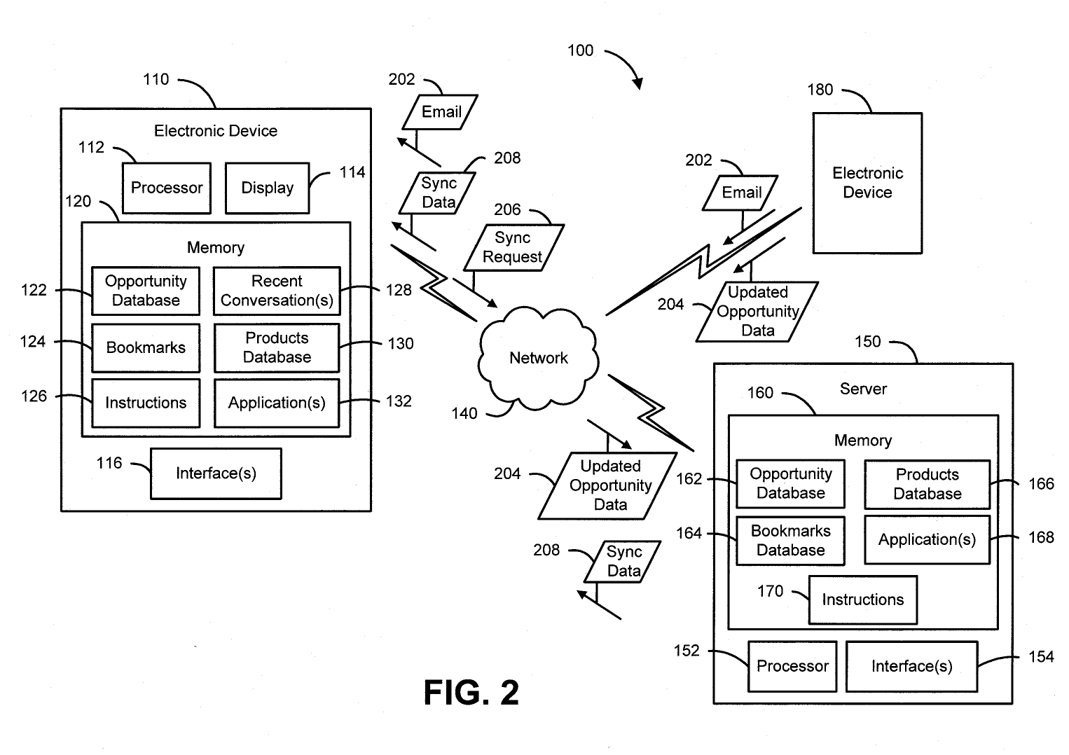

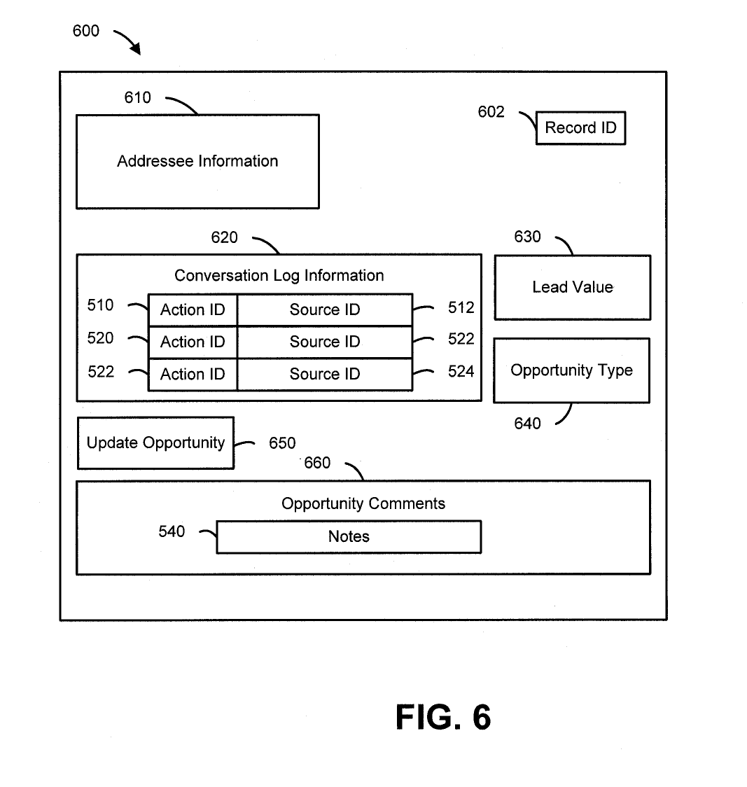

As shown in FIG. 1, the second electronic device 180 may receive the opportunity message 102 from the first electronic device 110 via the network 140. The portion of the conversation log 128 included in the opportunity message 102 may enable a user of the second electronic device 180 to identify the information presented to the customer by the sales representative. An illustrative embodiment of information that may be included in the opportunity message 102 is described with reference to FIG. 6. Although the opportunity message 102 is illustrated as being sent to the second electronic device 180, the opportunity message 102 may be sent to any number of devices based on the selections of intended recipients using the graphical user interface. For example, the opportunity message 102 may be sent to an additional device (not shown in FIGS. 1 and 2), such as an electronic device associated with a supervisor of the sales representative.

As described above, in an embodiment, the opportunity message 102 may include an icon or a link that, when selected, causes the application (e.g., a copy of the application(s) 132) running on the second electronic device 180 to sync with the server 150 (i.e., retrieve the opportunity data 104 from the opportunity database 162). For example, in response to receipt of the opportunity message 102, the user (e.g., the second sales representative) of the second electronic device 180 may select the icon or the link included in the opportunity message 102. In response to the selection of the icon or the link, the application running on the second electronic device 180 may transmit a sync request message 106 (e.g., a request to retrieve the opportunity data 104) to the server 150 via the network 140.

The server 150 may receive the sync request message 106 and, in response to receiving the sync request message 106, retrieve the opportunity data 104 from the opportunity database 162 and transmit the opportunity data 104 to the second electronic device 180. As shown in FIG. 1, the retrieved opportunity data 104 may be transmitted from the server 150 to the second electronic device 180 as sync data 108. In an embodiment, the sync data 108 may include the opportunity data 104 and other data (e.g., other opportunity data stored at the opportunity database 162). The other data may include information stored at the server 150 by other electronic devices (not shown in FIG. 1). The sync request 106 and the sync data 108 may be used to maintain the application running on the second electronic device 180 and the application(s) 132 running on the first electronic device 110 synchronized via the server 150.

In an embodiment, the server 150 may push (e.g., transmit) the sync data 108 to the second electronic device 180 without receiving the sync request message 106. For example, when the user of the second electronic device 180 opens or starts to run the application at the second electronic device 180, the server 150 may detect the opening of the application at the second electronic device 180 and, in response, may transmit the sync data 108 to the second electronic device 180. Thus, the server 150 may automatically synchronize the application running on the second electronic device 180 and the application(s) 132 running on the first electronic device 110. Synchronizing the first electronic device 110 and the second electronic device 180 may keep the users of the respective electronic devices 110, 180 informed of the information presented to the customer even if the first electronic device 110 is located remote from the second electronic device 180.

To illustrate, in a coordinated task environment, such as team selling, a sales representative may use the first electronic device 110 to present information (e.g., information stored in the products database 130) to a customer (e.g., a physician). The information may be associated with a particular product (e.g., a medical device) or a service (e.g., a medical billing service) that the sales representative believes is of interest to the customer. The information presented at the first electronic device 110 may be associated with the particular product or the particular service and may include audio content, video content, text content, image content, or a combination thereof. The information may be stored as one or more files, data records, and/or data structures within the products database 130.

Data identifying the information presented at the electronic device 110 may be automatically logged (e.g., stored) at the conversation log 128 and may identify the files, data records, and/or data structures presented to the customer. The conversation log 128 may also identify an order in which the identified files, data records, and/or data structures were presented to the customer. After the sales representative has finished presenting the information to the customer, the sales representative may provide an input to the first electronic device 110 requesting to transmit the opportunity message 102 to the second electronic device 180. The second sales representative may be employed by a manufacturer of the particular product or a provider of the particular service.

For example, after talking to the customer, the sales representative may request that the second sales representative follow-up with the customer to answer any additional questions that the customer may have and/or to present additional information regarding the particular product or the particular service. The opportunity message 102 may include notes that describe the information that has already been presented to the customer and may include additional information, such as notes inputted by the sales representative. The opportunity message 102 may enable the second sales representative to determine whether any additional information (e.g., information not identified in the opportunity message 102) is available for presentation to the customer during the follow-up visit. This may prevent the second sales representative from presenting duplicate information to the customer and may make the follow-up visit more effective because the second sales representative is able to present new information to the customer.

Additionally, the notes included in the opportunity message 102 may enable the second sales representative to determine whether additional information is available (e.g., additional information included in the products database 130) to present to the customer during the follow-up visit with the second sales representative. For example, the sales representative may include notes that indicate a particular question that the customer had regarding the particular product or the particular service. The second sales representative may be able to identify or generate, based on the opportunity message 102 (e.g., the notes and based on the portion of the conversation log 128), additional information that may be presented to the customer using the second electronic device 180 during the follow-up visit.

As shown in FIG. 1, the server 150 may include a processor 152, an interface(s) 154, and a memory 160. In an embodiment, the server 150 may be coupled to a display device (not shown in FIG. 1). The interface(s) 154 may include one or more of the interface(s) 116 described with reference to the first electronic device 110. The applications 168 may be stored as instructions 170 that, when executed by the processor 152, cause the processor 152 to perform the operations and functions described herein with reference to the server 150. As shown in FIG. 1, the memory 160 may store a bookmarks database 164. The bookmarks database 164 may store bookmark data that may be distributed to electronic devices for use in presenting information. For example, the server 150 may distribute bookmark data to the first electronic device 110. The first electronic device 110 may store the bookmark data in the bookmarks database 124 and the user of the first electronic device 110 may use a bookmark menu, generated by the application(s) 132 based on the bookmark data stored at the bookmark database 124, to select and present information from the products database 130 during a conversation with a customer. In an embodiment, the bookmark data included in the bookmark databases 124, 164 may be stored in an extensible markup language (XML) format. An illustrative embodiment of selecting and presenting information using a bookmark menu is described with reference to FIGS. 3 and 4.

Referring to FIG. 2, an illustrative embodiment of synchronizing updated opportunity data in the system 100 of FIG. 1 is shown. In FIG. 2, the first electronic device 110, the network 140, the server 150, and the second electronic device 180 of FIG. 1 are shown. The operations of the system 100 of FIG. 1, as described with reference to FIG. 2, may correspond to operations performed after the second sales representative has initiated a follow-up meeting with the customer.

As shown in FIG. 2, the second electronic device 180 may transmit an updated opportunity message 202 (e.g., an email message) to the first electronic device 110 via the network 140. The updated opportunity message 202 may be transmitted to the first electronic device 110 in response to an input received at the second electronic device 180. For example, after the second sales representative conducts the follow-up visit with the customer (e.g., using knowledge gained from the opportunity message 102 described with reference to FIG. 1), the second sales representative may provide an input that causes the application executing on the second electronic device 180 to present a graphical user interface that enables the second sales representative to select one or more contacts from a contact list. The graphical user interface may also enable the second sales representative to input additional information, such as additional notes, into the updated opportunity message 202. The updated opportunity message 202 may also include information from a conversation log of the second electronic device 180. The information from the conversation log of the second electronic device 180 may identify the additional information presented to the customer during the follow-up visit and may also identify the order in which the additional information was presented to the customer. In an embodiment, the updated opportunity message may be an email message. In an embodiment, the updated opportunity message 202 may include an updated opportunity record (e.g., an updated copy of the opportunity record stored at the opportunity database of the second electronic device 180) corresponding to the opportunity data 104. The first electronic device 110 may update the opportunity record stored at the opportunity database based on the updated opportunity record. Although the updated opportunity message 202 is illustrated as being sent to the first electronic device 110, the updated opportunity message 202 may be sent to any number of devices based on the selections of intended recipients using the graphical user interface. For example, the updated opportunity message 202 may be sent to an additional device (not shown in FIGS. 1 and 2), such as an electronic device associated with a supervisor of the second sales representative.

In addition to transmitting the updated opportunity message 202 to the first electronic device 110, the second electronic device 180 may transmit updated opportunity data 204 to the server 150. In an embodiment, the updated opportunity data 204 includes the information included in the updated opportunity message 202 (e.g., the information from the conversation log of the second electronic device and the additional notes). In an embodiment, the updated opportunity data 204 includes only the information stored at the conversation log of the second electronic device, the notes inputted by the second sales representative, and information that identifies changes to the opportunity data 104 (e.g., a changes sales amount or other information) and information included in the opportunity data 104 that is unchanged is not included in the updated opportunity data 104. In an embodiment, in response to receiving the updated opportunity data 204, the server 150 may determine whether to send a notification to one or more electronic devices associated with the opportunity record and the updated opportunity record (e.g., based on the first identifier). For example, the server 150 may update the opportunity data 104 based on the updated opportunity data 204 and may determine that a notification is to be sent to the second identifier associated with the first electronic device 110 to inform the application(s) 132 that the opportunity data 104 has been updated. The first electronic device 110 may receive the notification and the application(s) 132 may update the opportunity record stored at the opportunity database 122 accordingly.

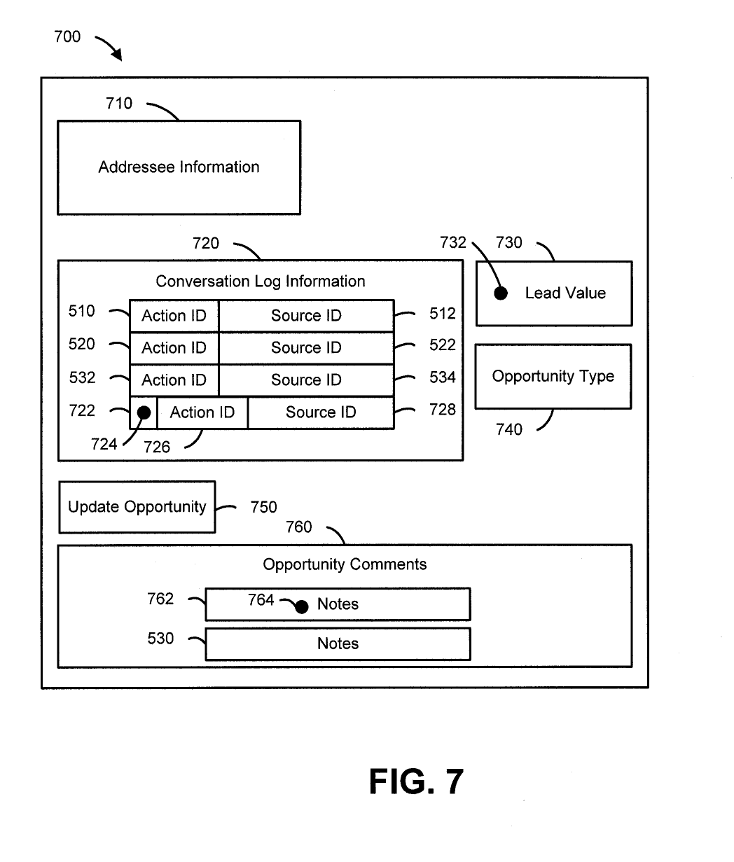

In an embodiment, in response to receiving the updated opportunity data 202, the first electronic device 110 may transmit a sync request 206 to the server via the network 140. In response to the sync request 206, the server 150 may transmit sync data 208 to the first electronic device. The sync data 208 may include the information included in the updated opportunity data 204 generated by the second electronic device 180. An illustrative embodiment of information that may be included in the sync data 208 is described with reference to FIG. 7. The first electronic device 110 may receive the sync data 208 from the server 150 via the network 140 and may update the opportunity record stored at the opportunity database 122 based on the sync data 208 to generate an updated opportunity record. The updated opportunity record stored at the opportunity database 122 may include the additional information included in the sync data 208 and may include at least a portion of the information included in the opportunity data 104, as described with reference to FIG. 7. In an embodiment, updating the opportunity record based on the sync data 208 may include replacing at least a portion of first information (e.g., a first potential sales lead amount) included in the opportunity record with the additional information (e.g., a second potential sales lead amount) included in the sync data 208. In an embodiment, updating the opportunity record based on the sync data 208 may include appending the additional information included in the sync data 208 to at least a portion of first information included in the opportunity record.

In an embodiment, the sync data 208 may include one or more badges (e.g., visual indicators) that may identify portions of information included in the sync data 208 that are different from, or in addition to the information included in the opportunity data 104. An illustrative embodiment of the one or more badges is described with reference to FIG. 7. In an embodiment, the one or more badges may identify a portion of first information (e.g., the opportunity data 104) that has been replaced with the additional information (e.g., the sync data 208). In an embodiment, the sync data 208 may include one or more badges that may identify the additional information that has been appended to at least the portion of the first information. In an embodiment, the one or more badges may be used to identify information that has been replaced and/or appended to the opportunity data 104 based on the sync data 208.

In an embodiment, the one or more badges may include multiple types of badges. For example, a first badge type may identify portions of information that have been replaced by the based on the sync data 208 and a second badge type may identify portions of information that have been appended to the record based on the sync data 208. Badges of the first badge type may be displayed in a first color and/or may have a first shape (e.g., a square) and badges of the second badge type may be displayed in a second color and/or may have a second shape (e.g., a circle). In response to receiving a request to display the updated record (e.g., the record updated based on the sync data 208) at the first electronic device 110, the first electronic device 110 may display the updated record that includes the additional information. Displaying the updated record may include displaying the one or more badges included in the updated record, as described with reference to FIG. 7. By including the badges in the updated opportunity message 202 and the updated opportunity data 204 (and the sync data 208), the user of the first electronic device 110 may be able to quickly identify changes and additional information related to the coordinated task (e.g., the sale of the product or the service).

Thus, the system 100, as described with reference to FIGS. 1 and 2, may enable multiple users to present information using multiple electronic devices as part of a coordinated task and to share information between the multiple electronic devices, such that, each time a change to the presented information occurs, information indicating the changes is transmitted or transferred to each of the electronic devices. As such, the multiple electronic devices are able to synchronously coordinate during performance of a shared task, eliminating the need for the multiple users to manually input data received from another user, or manually copy data to be transmitted to the other user. Thus, the system 100 may improve the interactions and coordination of members during performance of a shared. It is noted that, although many of the embodiments described with reference to FIGS. 1 and 2 have been illustrated with reference to examples of how the system 100 may be used in a team sales environment, the embodiments described herein are not to be so limited. Rather, the embodiments described herein may be applied in the performance of any task where information sharing between multiple users and multiple user devices may be desired.

Although the embodiments described herein with reference to FIGS. 1 and 2 illustrate the sharing information between the first electronic device 110 and the second electronic device 180 via the network 140, it is noted that other methods of communication information between the first electronic device 110 and the second electronic device 180 are within the scope of the present disclosure. For example, in an embodiment, information may be distributed directly between the first electronic device 110 and the second electronic device 180 using a peer-to-peer connection. Additionally, although the server 150 is illustrated as a stand-alone electronic device coupled to the network 140, the server 150 may be integrated within the network 140 (e.g., as a cloud storage device or networked storage device) or may be integrated within the first electronic device 110 or the second electronic device 180. For example, the first electronic device 110 may be designated as a master device (e.g., a server 150) and the second electronic device 180 may be designated as a slave device (e.g., a slave to the server 150 that is operating as part of the first electronic device 110).

Referring to FIG. 3, an illustrative embodiment of presenting information at the first electronic device 110 of FIG. 1 is shown. As shown in FIG. 3, the information may be presented within a display area 300 of the display device 114. The information illustrated in the display area 300 of FIG. 3 may correspond to a graphical user interface of an application (e.g., the application(s) 132 of FIG. 1) and may include information associated with a first product 310, a second product 320, a third product 330, a fourth product 340, and a fifth product 350.

As indicated by the arrow 302, a selection of the third product 330 may cause the display area 300 to be populated with information related to the third product 330. In an embodiment, the icon or other graphic used to represent the third product 330 may be presented at the top left corner (or other area) of the display area 300. As shown in FIG. 3, the information related to the third product 330 may include a first content item 332, a second content item 334, and a third content item 336. Each of the content items 332, 334, 336 may include information related to the third product 330. For example, each of the content items 332, 334, 336 may correspond to conversation content that, when presented at the display area 300, describes particular information regarding the third product 330. The conversation content may include audio content, video content, text content, image content, or a combination of audio content, video content, text content, and image content. Additionally, the conversation content may include interactive content, such as an interactive video that may be presented to the customer. The customer may interact with the interactive content which may increase the level of interest that the customer has for the particular product and may increase the amount of time that the customer is willing to spend with the sales representative.

A bookmark icon 360 may be presented within the display area 300. Selection of the bookmark icon 360 may cause the first electronic device 110 to present a bookmark menu 370, as indicated by the arrow 304. As shown in FIG. 3, the bookmark menu 370 may be presented as a graphical overlay on top of the content items 332, 334, 336. In an embodiment, the bookmark menu 370 may be presented in a new window or in another portion of the display area 300 instead of as a graphical overlay. The bookmark menu 370 includes a title bar 372 that may identify the particular product that the bookmark menu 370 is related to. For example, the title bar 372 may indicate that the bookmark menu 370 is associated with the third product 330.

The bookmark menu 370 may include a plurality of selectable elements arranged within a plurality of categories (e.g., conversation content labels). For example, in FIG. 3, the bookmark menu 370 includes a first conversation content label 380 and a second conversation content label 390. A first selectable element 382 and a second selectable element 384 may be arranged within bookmark menu 370 under the first conversation content label 380 and a third selectable element 392 and a fourth selectable element 394 may be arranged within the bookmark menu 370 under the second conversation content label 390. Each of the plurality of selectable elements 382, 384, 392, 394 may include information associated with a conversation topic included in a set of conversation topics related to a product and/or a service.

For example, the conversation topic label 380 may indicate a first conversation topic related to “features” of the product 330. A first set of selectable elements (e.g., the selectable elements 382, 384) may be associated with conversation content associated with the first conversation topic. The first set of selectable elements (e.g., the selectable elements 382, 384) may be arranged within the bookmark menu 370 based on the first conversation topic label 380 that identifies the first conversation topic (e.g., the “features” of the product 330). For example, the conversation content (e.g., audio content, video content, text content, image content, or a combination of these content types) associated with each of the selectable elements 382, 384 may describe the “features” of the product 330.

As shown in FIG. 3, a second set of selectable elements (e.g., the selectable elements 392, 394) may be arranged within the bookmark menu 370 based on the second conversation topic label 390 that identifies a second conversation topic (e.g., “benefits” of the product 330). The second set of selectable elements (e.g., the selectable elements 392, 394) may associated with conversation content associated with the second conversation topic. For example, the conversation content (e.g., audio content, video content, text content, image content, or a combination of these content types) associated with each of the selectable elements 392, 394 may describe the “benefits” of the product 330.

Arranging the selectable elements 382, 384, 392, 394 within the bookmark menu 374 using the conversation topic labels 380, 390 may enable a sales representative (or other user of the first electronic device 110) to quickly identify and present conversation content related to the “features” of the product 330 (e.g., using the selectable elements 382, 384) or to identify and present conversation content related to the “benefits” of the product 330 (e.g., using the selectable elements 392, 394). This may enable the customer to determine the direction that the conversation takes while also enabling the sales representative to quickly respond to the customers inquiries. For example, when the customer requests information related to a particular conversation topic, the sales representative can quickly identify one of the conversation topic labels 380, 392 that describes the particular conversation topic and present conversation content that describes the particular conversation topic using the selectable elements associated with the identified conversation topic label.

For example, and referring to FIG. 4, an illustrative embodiment of presenting conversation content at the first electronic 110 of FIG. 1 using the bookmark menu 374 of FIG. 3 is shown. As shown by the arrow 402, in response to receiving an input indicating a selection of a selectable element (e.g., the selectable element 392) of the plurality of selectable elements included in the bookmark menu 370, the electronic device 110 may initiate presentation of conversation content. In an embodiment, the conversation content may include multimedia content 410 (e.g., image content, video content, and/or audio content) and text content 412, as illustrated in FIG. 4. In another embodiment, the conversation content may include only text content, only image content, only audio/video content, or a combination of text content, image content, audio content, and video content. The first electronic device 110 may include a speaker 420 that may generate audio signals 422 representative of the audio content included in the multimedia content 410.

In response to the selection of the selectable element 392, the first electronic device 110 may update the conversation log 128 to indicate that the conversation content (e.g., the multimedia content 410 including the audio content 422, and the text content 412) was presented at the first electronic device 110. The selectable element 392 may be associated with the conversation topic label 390. As shown in FIGS. 3 and 4, the conversation topic label 390 may be related to the “benefits” of the product. The conversation content (e.g., the multimedia content 410 including the audio content 422, and the text content 412) presented at the first electronic device 110 may describe one or more of the “benefits” of the product 330. The first electronic device 110 may present additional conversation content in response to selections of additional selectable elements (e.g., the selectable elements 382, 384, 394) of the plurality of selectable elements, wherein the conversation log identifies an order in which each of the selections of the selectable elements occurred and identifies the conversation content that was presented in response to each of the selections of the selectable elements. The conversation content may include pricing information, product specification information, product demonstration information, product instructional information, workflow information, medical practitioner information, medical patient information, product comparison information, or a combination thereof.

Referring back to FIG. 3, the bookmark menu 370 may include an action icon 374. The action icon 374 may be used to transmit an opportunity message (e.g., the opportunity message 102 of FIG. 1 or the updated opportunity message 202 of FIG. 2) to one or more intended recipients (e.g., using a contacts list), as described with reference to FIG. 1. For example, at the conclusion of the conversation between the sales representative and the customer, the sales representative may select the action icon 374. Selection of the action icon 374 may cause a graphical user interface (not shown) to be displayed within the display area 300. The graphical user interface may enable the sales representative to select address information (e.g., an email address, a phone number, or other identifier) for one or more intended recipients from a contact list (not shown in FIG. 3). Additionally, the graphical user interface may enable the sales representative to type intended recipient address information (e.g., an email address, a phone number, or another identifier).

The graphical user interface may enable the sales representative to input additional information, such as notes describing the conversation between the sales representative and the customer or describing information that may be beneficial for presentation or demonstration during a follow-up conversation. In an embodiment, the additional information may include at least a portion of the information described with respect to the opportunity message 600 of FIG. 6. After the sales representative has entered the additional information and the intended recipient information, the sales representative may transmit the opportunity message (e.g., the opportunity message 102 of FIG. 1 or the updated opportunity message 202 of FIG. 2) to the intended recipients. In response to, or simultaneously with sending the opportunity message to the intended recipients, the first electronic device 110 may transmit the information included in the opportunity message to the server as opportunity data (e.g., the opportunity data 104 of FIG. 1 or the updated opportunity data 204 of FIG. 20, as described with reference to FIGS. 1 and 2.

In an embodiment, a user of the first electronic device 110 may generate a new selectable element to be included in the bookmark menu 370. For example, the bookmark menu 370 may include an icon 396 and a selection of the icon 396 may initiate presentation of a graphical user interface (not shown) that enables the user to generate the new selectable element. The first electronic device 110 may receive information that indicates a conversation topic associated with the new selectable element via the graphical user interface. The first electronic device 110 may associate the new selectable element with the indicated conversation topic. The first electronic device 110 may also receive information that identifies conversation content that is to be presented in response to selection of the new selectable element. The first electronic device 110 may associate the new selectable element with identified conversation content. The first electronic device 110 may present the new selectable element within a portion of the bookmark menu 370 identified by a particular conversation topic label associated with the indicated conversation topic. In an embodiment, the graphical user interface may enable the user of the first electronic device 110 to modify the respective menu positions of the selectable elements 382, 384, 392, 394, create new conversation topic labels, re-associate one or more of the selectable elements 382, 384, 392, 394 with a different conversation topic label, and other operations to modify the bookmark menu 370. After modifying the bookmark menu 370 at the first electronic device 110, the first electronic device 110 may transmit the modified bookmark menu 370 that includes the new selectable element to the server via a network (e.g., the network 140 of FIG. 1). The server may distribute the modified bookmark menu 370 that includes the new selectable element to one or more additional electronic devices (e.g., the second electronic device 180) via the network.

In an embodiment, the bookmark menu 370 may be pushed to the first electronic device 110 by a server (e.g., the server 150 of FIG. 1). For example, an electronic device (e.g., the second electronic device 180 of FIG. 1) associated with a manufacturer of a product may generate the bookmark menu 370 and may store the bookmark menu 370 at the server. The server may then push the bookmark menu 370 to the first electronic device 110 and the bookmark menu 370 may be stored in the bookmarks database 124 of FIG. 1. Additionally, the server may push the bookmark menu 370 to the first electronic device 110 in response to detecting a modification of the bookmark menu 370.

In an embodiment, modification of the bookmark menu 370 may include insertion of additional selectable elements into the bookmark menu 370, as described with reference to the icon 396. The additional selectable elements may identify additional conversation content that has been stored in a products database (e.g., the products database 166 of FIG. 1) at the server or at the first electronic device 110. When the additional conversation content is stored at the server, the bookmark menu 370 and the additional conversation content may be pushed from the server to the first electronic device 110. In an embodiment, the server 150 may send the bookmark menu 370 and the additional conversation content to the first electronic device 110 in response to a sync request (e.g., the sync request 206 of FIG. 2). The first electronic device 110 may receive the additional conversation content and the bookmark menu 370 from the server 150. The first electronic device 110 may store the bookmark menu 370 at the bookmark database 124 of FIG. 1 and may store the additional conversation content at the products database 130 of FIG. 1.

The bookmark menu 370 may include a search text box 398 that may be used to search for conversation content, conversation topic labels, products, or other information. After performing a search using the search text box 398, the search results may be presented within the bookmark menu 370 or in another window or menu. When the search results are presented within the bookmark menu 370, the bookmark menu 370 may include a conversation topic label that identifies selectable elements related to “search results.” The search text box 398 of the bookmark menu 370 may enable a user of the first electronic device 110 to quickly find additional information (e.g., additional products similar to, or complimentary to the product 330) to present at the first electronic device 110.

By creating the bookmark menu 370 and associating the selectable elements included in the bookmark menu 370 with the conversation content, a user of the electronic device 110 may more quickly access conversation content that directly relates to a particular topic of interest (e.g., a topic of interest to a customer). For example, in a sales environment, when a sales representative meets with a customer to discuss a particular product (e.g., the product 330), the customer may drive the conversation by inquiring about a particular aspect of the particular product. To illustrate using the bookmark menu 370 of FIGS. 3 and 4, when the customer wants to see information about a particular “feature” of the particular product, the sales representative may quickly present information (e.g., conversation content) that describes the particular “feature” by selecting the selectable element 382 or the selectable element 384. When the customer wants to see information about a particular “benefit” of the particular product, the sales representative may quickly present information that describes the particular “benefit” by selecting the selectable element 392 or the selectable element 394.

Additionally, by storing modifications to the bookmark menu 370 at the server, the bookmark menu 370 may be kept up to date across multiple electronic devices that may be remotely located. For example, when the first electronic device 110 modifies the bookmark menu 370, the modified bookmark menu 370 may be stored at the bookmark database 124 and may be transmitted to the server. The server may store the modified bookmark menu 370 (e.g., at the bookmarks database 164) and may transmit the modified bookmark menu 370 to other electronic devices (e.g., the second electronic device 180). Synchronizing the bookmarks menu 370 across multiple electronic device via the server in response to changes made to the bookmark menu 370 at a single device may enable better communication between users of electronic device that are remotely located from each other.

For example, a sales representative of a distributor may send an opportunity message (e.g., the opportunity message 102 of FIG. 1) to an electronic device (e.g., the second electronic device 180 of FIG. 1) associated with a manufacturer of a particular product. A notes portion of the opportunity request may indicate that the customer has requested information about a particular aspect (e.g., a feature, a benefit, a how to use demonstration, etc.) of the product discussed during a conversation between the sales representative and the customer. Personnel of the manufacturer may receive the opportunity message, and, in response to the notes portion of the opportunity message, update the bookmark menu 370 to include a selectable element related to the particular aspect of the product requested by the customer. The updated bookmark menu 370 may be stored at the server and distributed to the first electronic device 110 and other electronic devices. Additionally, the additional content describing the particular aspect of the product may be stored at the server and distributed to the first electronic device 110 and the other electronic devices. Thus, multiple electronic devices may be synchronized quickly after changes to information (e.g., the bookmark menu 370 or a products database) stored across the multiple electronic devices.

Referring to FIG. 5, an illustrative embodiment of an opportunity record generated based on a conversation log is shown and designated 500. In an embodiment, the opportunity record 500 may be the opportunity data 104 of FIG. 1. In another embodiment, the opportunity record 500 may be the updated opportunity data 204 of FIG. 2. As shown in FIG. 5, the opportunity record 500 may include intended recipient information 502, a record identifier 504, one or more device identifiers 506, a first entry that includes action information 510 and source information 512, a second entry that includes action information 520 and source information 522, a third entry that includes action information 530 and source information 532, and notes information 540. The intended recipient information 502 may include names, addresses, or other information associated with the intended recipients (e.g., selected using the contacts list as described with reference to FIGS. 1-4) that received an opportunity message (e.g., the opportunity message 102 of FIG. 2 or the updated opportunity message 202 of FIG. 2) associated with the opportunity record 500. The record identifier 504 may correspond to information that uniquely identifies the opportunity record 500, as described with reference to the first identifier in FIGS. 1 and 2. The device identifier information 506 may include information that identifies electronic devices (e.g., the first electronic device 110 and/or the second electronic device 180) that are to receive notifications from a server (e.g., the server 150 of FIGS. 1 and 2) in response to modifications, changes, or updates to the opportunity record 500. In an embodiment, the device identifier information 506 may correspond to the second identifier and/or the third identifier described with reference to FIGS. 1 and 2.

The first entry, the second entry, and the third entry may correspond to the information stored in the conversation log 128 described with reference to FIG. 1 and may identify information that was presented (e.g., to a customer) at an electronic device (e.g., the first electronic device 110 or the second electronic device 180). For example, the first entry may identify first information presented at the electronic device, the second entry may identify second information presented at the electronic device, and the third entry may identify third information presented at the electronic device. The action information 512, 522, 532 may indicate an action that was performed with respect to the information presented at the electronic device. For example, the action information 510 may indicate that content associated with the source information 512 was “shown,” the action information 520 may indicate that content associated with the source information 522 was “demonstrated,” and the action information 530 may indicate that content associated with the source information 532 was “shown.” Action information indicating that content was shown, such as the action information 510, may indicate that content identified by the source information 512 was presented to the customer at the display 114 of the first electronic device 110. When action information indicates that content was demonstrated, this may indicate that a demonstration of a product was presented to the user. The demonstration of the product may be a video presented at the display device 114 or may indicate that a live demonstration was performed. Additionally, an action identifier indicating demonstrated may indicate that the user received a demonstration via interactive content presented at the display device 114.

In an embodiment, an order in which the entries are included in the opportunity record 500 may indicate an order of presentation of content identified by the source information entries 512, 522, 532. For example, a first entry may be located above a second entry indicating that first information (e.g., the source information 512) was presented prior to second information (e.g., the source information 522) identified by the second entry. Alternatively, the first entry located above the second entry may indicate that the second entry was presented prior to the first entry. In an embodiment, timestamps may be used to indicate the order of presentation.

The opportunity record 500 may be stored at a database (e.g., the opportunity database 122 of FIG. 1) stored at a memory (e.g., the memory 120 of FIG. 1) of a first device (e.g., the first electronic 110 of FIG. 1), and/or at a database (e.g., the opportunity database 162 of FIG. 1) stored at a memory (e.g., the memory 160 of FIG. 1) of a server (e.g., the server 150 of FIG. 1). By storing the opportunity record 500 at the database of the server, the opportunity record 500 may be distributed via the server to other electronic devices (e.g., the second electronic device 180) in order to synchronize the other electronic devices with the first electronic device (e.g., the first electronic device 110).

Referring to FIG. 6, an illustrative embodiment of an opportunity message is shown and designated 600. In an embodiment, the opportunity message 600 may be the opportunity message 102 of FIG. 1. As shown in FIG. 6, the opportunity message 600 may include an opportunity record identifier 602 and addressee information 610 that may identify one or more intended recipients of the opportunity message 600. The record identifier 602 may correspond to a unique identifier associated with an opportunity record (e.g., the opportunity record 500 of FIG. 5). For example, a value of the record identifier 602 may be the same as a value of the record identifier 504 of FIG. 5 and the opportunity message 600 may be associated with the opportunity record 500 of FIG. 5. Intended recipients of the opportunity message 600 may be identified in the addressee information 610 and may include supervisors, sales team members, product manufacturers representatives, and other individuals. The opportunity message 600 includes conversation log information 620, lead value information 630, opportunity type 640, an update opportunity button 650, and an opportunity comments 660.

The conversation log information 620 may include the information logged in the conversation log 128 of FIG. 1. When the intended recipients receive the opportunity message 600, the conversation log information 620 may inform the intended recipients of the content that has been presented or provided to a potential customer based on the action information 510, 520, 530 of FIG. 5 and the source information 512, 522, 532 of FIG. 5. The lead value information 630 may indicate a potential sales value (e.g., a dollar value, a number of units to be purchased, etc.). The lead value information 630 may enable a second sales person to get more accurate quotes on pricing, determine more accurate lead times, estimate delivery dates, etc. and other information that may be useful to the second sales representative during a follow-up visit. The opportunity type information 640 may indicate a level of interest of a potential customer after an initial conversation has taken place. The level of interest may indicate that the potential customer is “interested” in the product or the service, “not interested” in the product or service, etc. Additionally, the opportunity type information 640 may indicate other information in additional to the level of interest. For example, when a customer has requested samples of a product or service, the opportunity type information 640 may indicate “samples ordered.”

The update opportunity button 650 may be used to generate a sync request, such as the sync request 106 of FIG. 1 or the sync request 206 of FIG. 2. The opportunity comments 660 may include notes input by a user of the electronic device. The notes 540 included in the opportunity comments 660 may be the notes 540 described with reference to FIG. 5.

As described with reference to FIG. 1, a first sales representative may visit a customer and present information to the potential customer using an electronic device (e.g., the electronic device 110). The presented information may be logged in a conversation log (e.g., the conversation log 128). When the conversation has concluded, the sales representative may provide an input (e.g., selection of the icon 374 of FIG. 3) to the electronic device. The input may request transmission of the conversation log to a second electronic device (e.g., the second electronic device 180), as described with reference to FIG. 1. An application (e.g., the application(s) 132 of FIG. 1), may present a graphical user interface to the sales representative that enables the sales representative to select the intended recipients (identified in the addressee information 610) from a contact list. Additionally, the graphical user interface may enable the sales representative to enter the lead value information 630 and enter the opportunity type information 640. Thus, the opportunity message 600 may provide a fast way to communicate opportunity information to members involved in performance of a coordinated task. Additionally, the opportunity message 600 may provide a mechanism (e.g., the update opportunity button 650) to synchronize information between electronic devices used to perform a coordinated task.

Referring to FIG. 7, an illustrative embodiment of an updated opportunity message is shown and designated 700. As shown in FIG. 7, the updated opportunity message 700 includes the same sections of information that each store the same type of information as the opportunity message 600 of FIG. 6. For example, the addressee information 710 stores information that identifies one or more intended recipients of the updated opportunity message 700. The conversation log information 720 includes the conversation log information 620 of FIG. 6 and includes an additional entry 722. As shown in FIG. 7, the additional entry 722 includes a badge 724 (e.g., black circle) positioned proximate to the action information 726 and the source information 728. The badge 724 may indicate that the entry 722 was not included in a previous version of the updated opportunity message 700 (e.g., the entry 722 was not included in the opportunity message 600). A user viewing the updated opportunity message 700 may be able to quickly determine that the entry 722 is new and thus quickly determine portions of the updated opportunity message 700 that contain new or previously unseen information.

As shown in FIG. 7, the lead value information 730 may include a second badge 732 that indicates the lead value information 730 differs from the lead value information 630 described with reference to FIG. 6. The opportunity type 740 may be the same as the opportunity type 640 of FIG. 6. The update opportunity button 750 may cause a recipient electronic device (e.g., the first electronic device 110 of FIG. 1) to update a local database (e.g., the opportunity database 122 of FIG. 1). The recipient electronic device may update the local database by transmitting a sync request message (e.g., the sync request 106 of FIG. 1 or the sync request message 206 of FIG. 2) to a server (e.g., the server 150 of FIG. 1).

As shown in FIG. 7, the opportunity comments 740 may include updated notes 762. The updated notes 762 may be indicated as new information by the badge 764. In an embodiment, the updated notes 762 may correspond to information input by the second sales representative after performing the follow-up visit, as described with reference to FIG. 2. By indicating changes, new information, and other modifications to the opportunity information using the badges 724, 732, 764, a user viewing the updated opportunity message 700 may more quickly identify the new or previously unseen information included in the updated opportunity message 700.

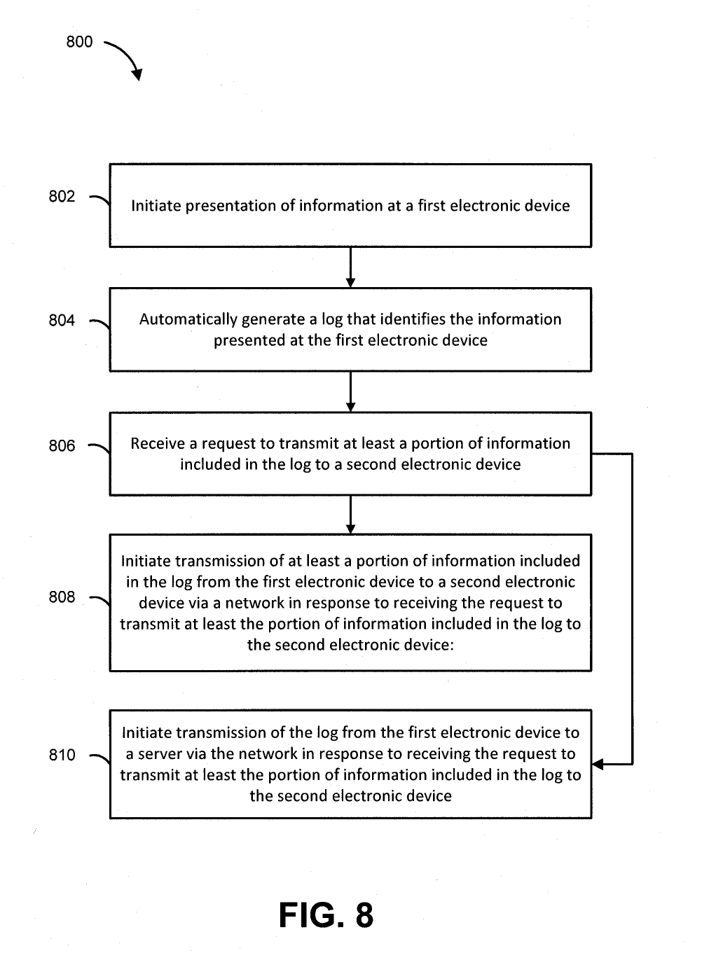

Referring to FIG. 8, a flowchart of an illustrative embodiment of a method of sharing information between multiple electronic devices involved in a coordinated task is shown and designated 800. At 802, the method 800 includes initiating presentation of information at a first electronic device. In an embodiment, the first electronic device may be the first electronic device 110 of FIGS. 1 and 2. At 804, the method 800 includes automatically generating a log that identifies information presented at a first electronic device. In an embodiment, the log may be the conversation log 128 of FIG. 1. At 806, the method includes receiving a request to transmit at least a portion of information included in the log to a second electronic device. In an embodiment, the second electronic device may be the second electronic device 180 described with reference to FIGS. 1 and 2. In response to receiving the request to transmit at least the portion of the information included in the log to the second electronic device, the method 800 includes, at 808, initiating transmission of at least the portion of the information included in the log from the first electronic device to the second electronic device via a network, and, at 810, initiating transmission of the log from the first electronic device to a server via the network. In an embodiment, the server may be the server 150 of FIGS. 1 and 2, and the network may be the network 140 of FIGS. 1 and 2. The server may be configured to store the log in a database. In an embodiment, the server may store the log in an opportunity database, such as the opportunity base 162 described with reference to FIGS. 1 and 2. The log may be accessible to the second electronic device via the server.

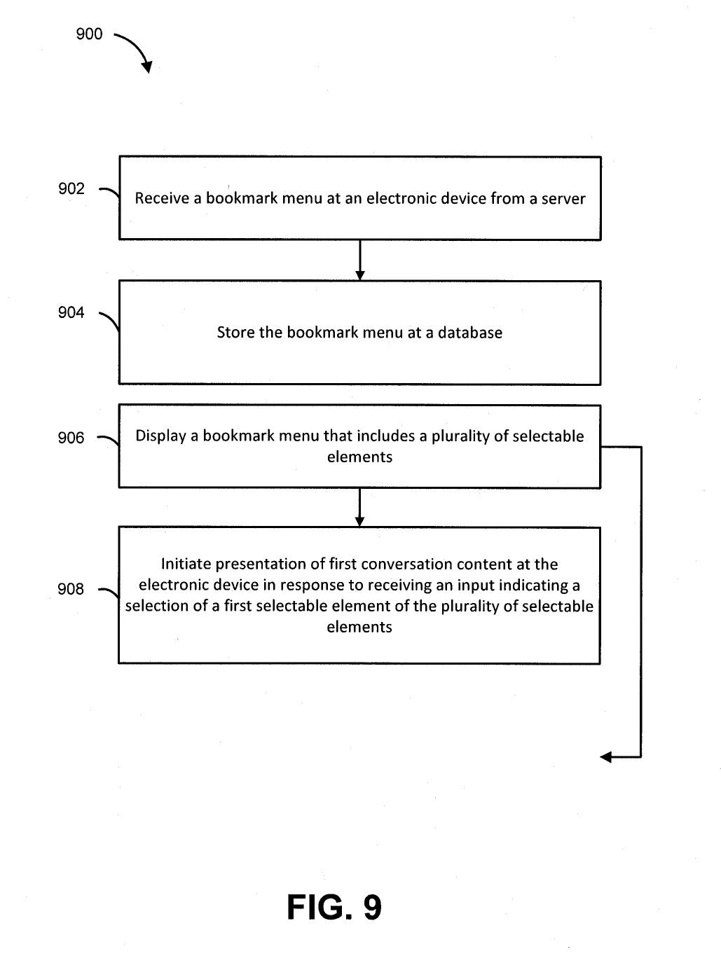

Referring to FIG. 9, a flowchart of an illustrative embodiment of a method of presenting conversation content using a bookmark menu that includes a plurality of selectable elements is shown and designated 900. The method 900 includes, at 902, receiving a bookmark menu at an electronic device from a server. In an embodiment, the electronic device may be the first electronic device 110 of FIG. 1 and the server may be the server 150 of FIG. 1. In an embodiment, the bookmark menu may be the bookmark menu 370 of FIG. 3. At 904, the method 900 includes storing the bookmark menu. In an embodiment, the bookmark menu may be stored at the bookmark database 124 of FIG. 1. The method 900 includes, at 906, displaying a bookmark menu that includes a plurality of selectable elements. In an embodiment, the bookmark menu may be presented during presentation of information associated with at least one of a product and a service at an electronic device, as described with reference to FIG. 3. Each of the plurality of selectable elements included in the bookmark menu may be associated with a conversation topic included in a set of conversation topics related to at least one of the product and the service. The method 900 may include, at 908, initiating presentation of first conversation content at the electronic device in response to receiving an input indicating a selection of a first selectable element of the plurality of selectable elements. The first conversation content may be associated with a first conversation topic related to at least one of the product and the service.

According to one or more of the embodiments described herein with reference to FIGS. 1-9, electronic devices used to perform at least a portion of a coordinated task may quickly synchronize information using opportunity messages and subsequently synchronize applications (e.g., the application(s) 132) via opportunity data stored at a server. Synchronizing the information using the opportunity messages may enable participants in a coordinated task to quickly identify information that has already been presented and to identify information that has not been presented and may enable the participants in the coordinated task to complete the task more quickly. In a team sales environment, the ability to quickly synchronize information between participants (e.g., sales team members) may enable the participants to more effectively communicate with customers, which in turn may result in more closed sales deals and increased customer satisfaction.

Additionally, according to one or more of the embodiments described herein with reference to FIGS. 1-9, a bookmark menu may be distributed to multiple electronic devices, updated by multiple electronic devices, and/or modified by the multiple electronic devices. When the bookmark menu is updated or modified at a first electronic device of the multiple devices, the updated bookmark menu may be stored at a server and distributed to the other electronic devices of the multiple electronic devices. Thus, one or more of the embodiments described herein may enable synchronization of bookmark menus that may be used to more effectively present information during a conversation, as described with reference to FIGS. 3 and 4. The use of a bookmark menu that is organized according to aspects of the product associated with the bookmark menu may enable presentation of information more quickly. Being able to find relevant information quickly (e.g., using the bookmark menu) may make the sales representative (or other person involved in a coordinated task) appear more knowledgeable about a product being sold. This may increase the number of sales deals that the sales person is able to complete, leading to larger revenues for companies employing an electronic device according to one or more of the embodiments described herein with reference to FIGS. 1-9.

Although the present invention and its advantages have been described in detail, it should be understood that various changes, substitutions and alterations can be made herein without departing from the spirit and scope of the invention as defined by the appended claims. Moreover, the scope of the present application is not intended to be limited to the particular embodiments of the process, machine, manufacture, composition of matter, means, methods and steps described in the specification. As one of ordinary skill in the art will readily appreciate from the disclosure of the present invention, processes, machines, manufacture, compositions of matter, means, methods, or steps, presently existing or later to be developed that perform substantially the same function or achieve substantially the same result as the corresponding embodiments described herein may be utilized according to the present invention. Accordingly, the appended claims are intended to include within their scope such processes, machines, manufacture, compositions of matter, means, methods, or steps.

What is claimed is:

1. A method comprising:
during presentation of information associated with at least one of a product and a service at an electronic device:
displaying a bookmark menu that includes a plurality of selectable elements, wherein each of the plurality of selectable elements is associated with a conversation topic included in a set of conversation topics related to at least one of the product and the service; and
in response to receiving an input indicating a selection of a first selectable element of the plurality of selectable elements, initiating presentation of first conversation content at the electronic device, wherein the first conversation content is associated with a first conversation topic related to at least one of the product and the service.

2. The method of claim 1, further comprising updating a conversation log to indicate that the first conversation content was presented at the electronic device in response to the selection of the first selectable element.

3. The method of claim 2, further comprising:
in response to receiving a second input indicating a selection of a second selectable element of the plurality of selectable elements, initiating presentation of second conversation content at the electronic device, wherein the second conversation content is associated with a second conversation topic related to at least one of the product and the service; and
updating the conversation log to indicate that the second conversation content was presented at the electronic device in response to the selection of the second selectable element.

4. The method of claim 3, wherein the bookmark menu is pushed to the electronic device by a server.

5. The method of claim 4, wherein the server pushes the bookmark menu to the electronic device in response to detecting a modification of the bookmark menu.

6. The method of claim 5, wherein the modification of the bookmark menu includes insertion of additional selectable elements into the bookmark menu, wherein the method further comprises receiving additional conversation content from the server, wherein the additional conversation content is associated with the additional selectable elements.

7. The method of claim 1, wherein the bookmark menu includes conversation topic labels that identify each conversation topic included in the set of conversation topics, wherein a first set of selectable elements of the plurality of selectable elements is arranged within the bookmark menu based on a first conversation topic label that identifies the first conversation topic, and wherein each selectable element included in the first set of selectable elements is associated with the first conversation topic.

8. The method of claim 1, wherein a second set of selectable elements of the plurality of selectable elements is arranged within the bookmark menu based on a second conversation topic label that identifies a second conversation topic, and wherein each selectable element included in second set of selectable elements is associated with the second conversation topic.

9. The method of claim 1, wherein the conversation content includes text content, audio content, video content, image content, or a combination thereof.

10. An apparatus comprising:
a processor; and
a memory coupled to the processor, the memory storing instructions that, when executed by the processor, cause the processor to perform operations comprising:
during presentation of information associated with at least one of a product and a service at an electronic device:
displaying a bookmark menu that includes a plurality of selectable elements, wherein each of the plurality of selectable elements is associated with a conversation topic included in a set of conversation topics related to at least one of the product and the service; and
in response to receiving an input indicating a selection of a first selectable element of the plurality of selectable elements, initiating presentation of first conversation content at the electronic device, wherein the first conversation content is associated with a first conversation topic related to at least one of the product and the service.

11. The apparatus of claim 10, wherein the operations include updating a conversation log to indicate that the first conversation content was presented at the electronic device in response to the selection of the first selectable element.

12. The apparatus of claim 11, wherein the operations include:
in response to receiving a second input indicating a selection of a second selectable element of the plurality of selectable elements, initiating presentation of second conversation content at the electronic device, wherein the second conversation content is associated with a second conversation topic related to at least one of the product and the service; and
updating the conversation log to indicate that the second conversation content was presented at the electronic device in response to the selection of the second selectable element.

13. The apparatus of claim 12, wherein the operations include initiating presentation of additional conversation content in response to selections of additional selectable elements of the plurality of selectable elements, wherein the conversation log identifies an order in which each of the selections of the selectable elements occurred and identifies the conversation content that was presented in response to each of the selections of the selectable elements.

14. The apparatus of claim 10, wherein the first conversation content includes pricing information, product specification information, product demonstration information, product instructional information, workflow information, medical practitioner information, medical patient information, product comparison information, or a combination thereof.

15. The apparatus of claim 10, wherein the bookmark menu includes conversation topic labels that identify each conversation topic included in the set of conversation topics, and wherein the operations include:
generating a new selectable element to be included in the bookmark menu;
receiving information that indicates a conversation topic associated with the new selectable element;
associating the new selectable element with the indicated conversation topic;
receiving information that identifies conversation content that is to be presented in response to selection of the new selectable element;
associating the new selectable element with identified conversation content; and
presenting the new selectable element within a portion of the bookmark menu identified by a particular conversation topic label associated with the indicated conversation topic.

16. The apparatus of claim 15, wherein the operations include transmitting the bookmark menu that includes the new selectable element to a server via a network, wherein the server distributes the bookmark menu that includes the new selectable element to the one or more additional electronic device via the network.

17. The apparatus of claim 10, wherein the processor and the memory are integrated into tablet computing device, a wireless communication device, a smartphone device, a laptop computing device, a personal computing device, a gaming device, or a personal digital assistant device.

18. A computer-readable storage device comprising instructions that, when executed by the processor, cause the processor to perform operations comprising:
during presentation of information associated with at least one of a product and a service at an electronic device:
displaying a bookmark menu that includes a plurality of selectable elements, wherein each of the plurality of selectable elements is associated with a conversation topic included in a set of conversation topics related to at least one of the product and the service; and
in response to receiving an input indicating a selection of a first selectable element of the plurality of selectable elements, initiating presentation of first conversation content at the electronic device, wherein the first conversation content is associated with a first conversation topic related to at least one of the product and the service.

19. The apparatus of claim 17, wherein the operations include:
in response to receiving a second input indicating a selection of a second selectable element of the plurality of selectable elements, initiating presentation of second conversation content at the electronic device, wherein the second conversation content is associated with a second conversation topic related to at least one of the product and the service; and
updating the conversation log to indicate that the second conversation content was presented at the electronic device in response to the selection of the second selectable element.

20. The apparatus of claim 18, wherein the bookmark menu includes conversation topic labels that identify each conversation topic included in the set of conversation topics, and wherein the operations include:
generating a new selectable element to be included in the bookmark menu;
receiving information that indicates a conversation topic associated with the new selectable element;
associating the new selectable element with the indicated conversation topic;
receiving information that identifies conversation content that is to be presented in response to selection of the new selectable element;
associating the new selectable element with identified conversation content;
presenting the new selectable element within a portion of the bookmark menu identified by a particular conversation topic label associated with the indicated conversation topic; and
transmitting the bookmark menu that includes the new selectable element to a server via a network, wherein the server distributes the bookmark menu that includes the new selectable element to the one or more additional electronic device via the network.
